(19) United States
(12) Patent Application Publication
(10) Pub. No.: US 2012/0002117 A1
(43) Pub. Date: Jan. 5, 2012

(54) LIGHTING DEVICE, DISPLAY DEVICE, AND TELEVISION RECEIVER

(75) Inventor: Shinji Matsumoto, Osaka-shi (JP)

(73) Assignee: SHARP KABUSHIKI KAISHA, Osaka-shi, Osaka (JP)

(21) Appl. No.: 13/255,576

(22) PCT Filed: Dec. 15, 2009
(86) PCT No.: PCT/JP2009/070867

§ 371 Date: Sep. 9, 2011

(30) Foreign Application Priority Data
Mar. 13, 2009 (JP) 2009-061241

(51) Int. Cl. H04N 5/66; G09F 13/04; F21S 2/00

(52) U.S. Cl. 348/739; 362/458; 362/97.1; 348/E05.133

(57) ABSTRACT

A lighting device 12 according to the present invention includes: a light source 18; a power supply board 20 configured to supply drive power to the light source 18; and a connector 21 that electrically connects the light source 18 to the power supply board 20. The power supply board 20 includes a connecting portion 20c connected with the connector 21 so as to be electrically connected to the light source 18 via the connector 21. The connecting portion 20c includes a rounded corner 20f.

### TECHNICAL FIELD

The present invention relates to a lighting device, a display device and a television receiver.

### BACKGROUND ART

A liquid crystal panel included in a liquid crystal display device such as a liquid crystal television receiver does not emit light. Therefore, a backlight unit that is required as a separate lighting unit. The backlight unit is arranged behind the liquid crystal panel (on an opposite side from the display surface). It includes a chassis, a number of lamps such as cold cathode tubes, and an inverter board. The chassis has an opening in a surface on the liquid crystal panel side. The cold cathode tubes are housed in the chassis. It is arranged so as to cover the opening of the chassis and configured to effectively direct rays of light emitted from the cold cathode tubes toward the liquid crystal panel. The inverter board is provided for supplying power to the lamps.

Patent Document 1 discloses an example configuration for making electrical connection between an inverter board and cold cathode tubes. In this configuration, the lamps are arranged on the front side inside the chassis and the inverter board is arranged on the rear side outside the chassis. Lamp holders are mounted to the chassis so as to penetrate through the chassis. The lamps are connected to internal ends of the lamp holders. The inverter board is connected to external ends of the lamp holders.

### Patent Document

Patent Document 1: Japanese Unexamined Patent Application Publication No. 2007-280955

### Problem to Be Solved by the Invention

The inverter board disclosed in Document 1 is connected to the lamp holder as follows. First, the inverter board is held with a surface facing the back surface of the chassis. Next, the inverter board is horizontally slid and is fitted into the lamp holder. At this time, as the inverter board is being fitted into the lamp holder, a corner of the inverter board may contact a corner of the lamp holder. Therefore, the inverter board cannot be smoothly fitted. Furthermore, the inverter board may be damaged.

### DISCLOSURE OF THE PRESENT INVENTION

The present invention was made in view of the foregoing circumstances, and its object is to prevent damages when the power supply board and the connector are being assembled together.

### Means for Solving the Problem

In order to solve the above-described problem, a lighting device according to the present invention includes: a light source; a power supply board configured to supply drive power to the light source; and a connector that electrically connects the light source to the power supply board. The power supply board includes a connecting portion connected with the connector so as to be electrically connected to the light source via the connector. The connecting portion includes a rounded corner.

The power supply board is connected to the connector in a manner as follows. First, the power supply board is held with the connecting portion facing the connector. Next, the power supply board is moved toward the connector. Then, the corner of the connecting portion may contact a part of the connector. As a countermeasure for this, the corner to contact the connector is rounded, which is the rounded corner of the power supply board. Because of this, the rounded corner of the power supply board is guided along the connecting portion of the connector when the power supply board is being fitted with the connector to be mounted thereto. This reduces the stress due to the contact. Because of this, the power supply board can be smoothly connected to the connector. This prevents damage to the power supply board.

### BRIEF DESCRIPTION OF THE DRAWINGS

FIG. 1 is an exploded perspective view schematically illustrating a television receiver of a first embodiment according to the present invention;

FIG. 2 is a sectional view illustrating a section along a long side of a liquid crystal display device;

FIG. 3 is a plan view illustrating a chassis with cold cathode tubes housed therein;

FIG. 4 is an enlarged bottom view illustrating the chassis with a cover thereon;

FIG. 5 is a sectional view along line A-A in FIG. 4, with an inverter board at a removal position;

FIG. 6 is a sectional view along line B-B in FIG. 4;

FIG. 7 is a bottom view illustrating the chassis with the inverter board mounted thereto;

FIG. 8 is an enlarged bottom view illustrating the inverter board;

FIG. 9 is an enlarged bottom view illustrating a main part with the inverter board at a non-connected position;

FIG. 10 is a sectional view along line C-C in FIG. 9;

FIG. 11 is an enlarged bottom view illustrating the main part of the inverter board at a connected position;

FIG. 12 is a sectional view along line D-D in FIG. 11;

FIG. 13 is a sectional view along line E-E in FIG. 11;

FIG. 14 is an enlarged bottom view illustrating an inverter board of a second embodiment according to the present invention;

FIG. 15 is a sectional view illustrating a connector;

FIG. 16 is an enlarged bottom view illustrating a main part with the inverter board located at the non-connected position; and

FIG. 17 is an enlarged bottom view illustrating the main part with the inverter board located at the connected position.

### BEST MODE FOR CARRYING OUT THE INVENTION

### First Embodiment

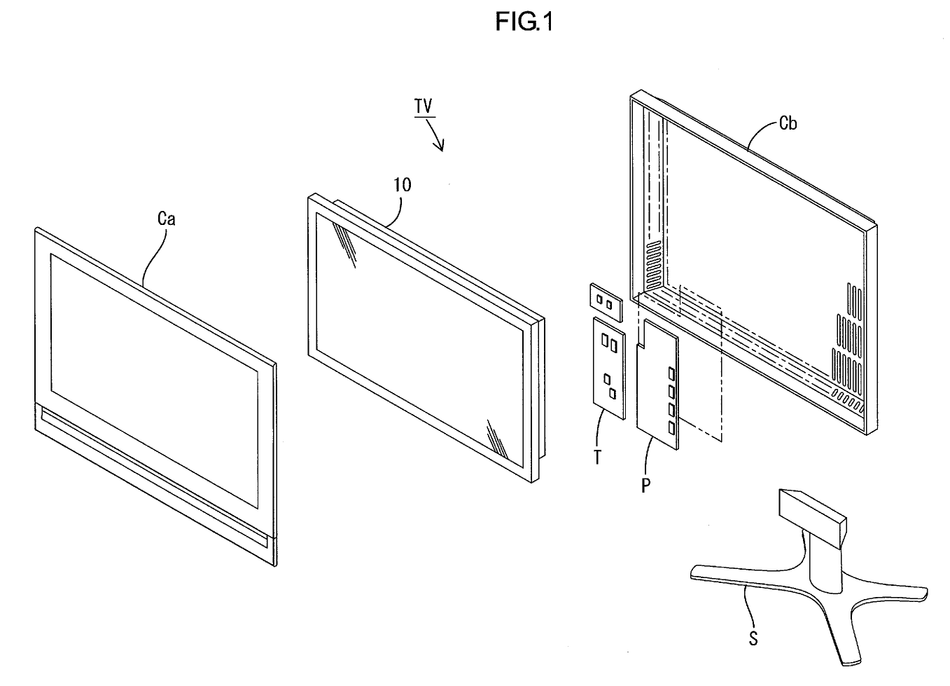

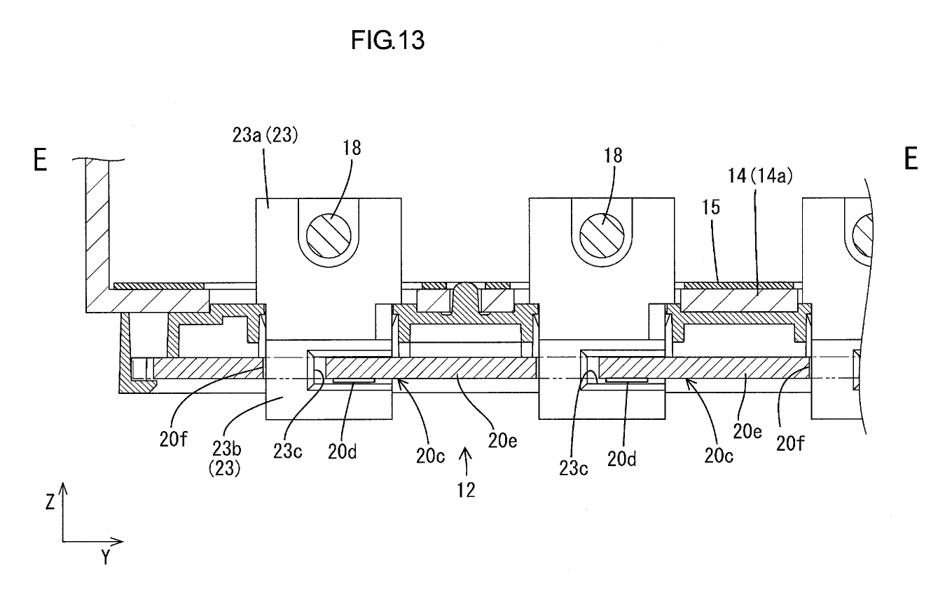

A first embodiment according to the present invention will be described with reference to FIGS. 1 to 13. This embodiment illustrates a television receiver TV including a liquid crystal display device 10.

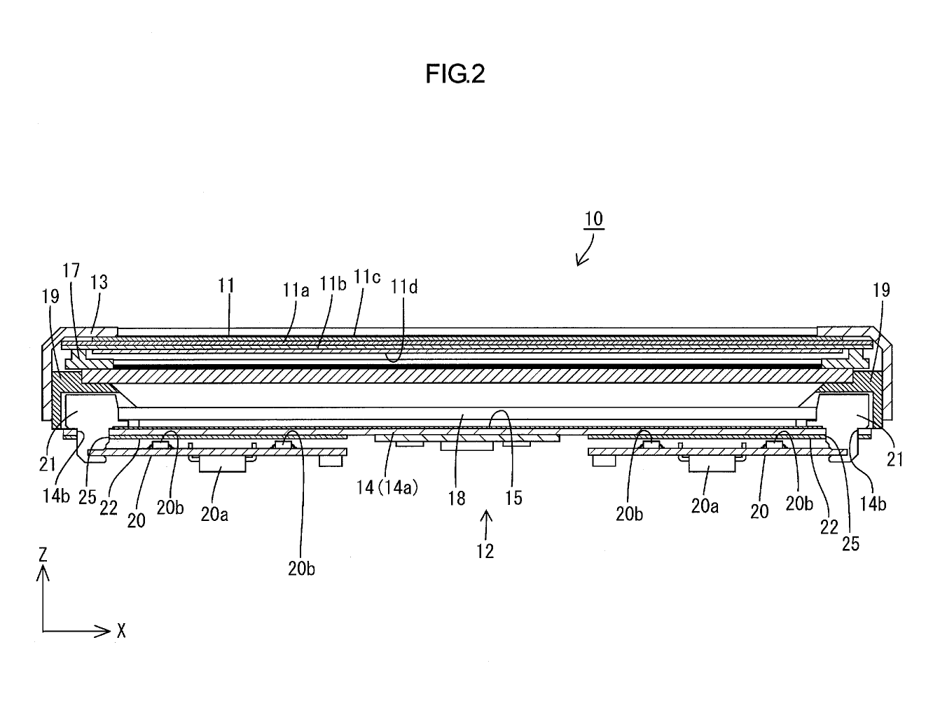

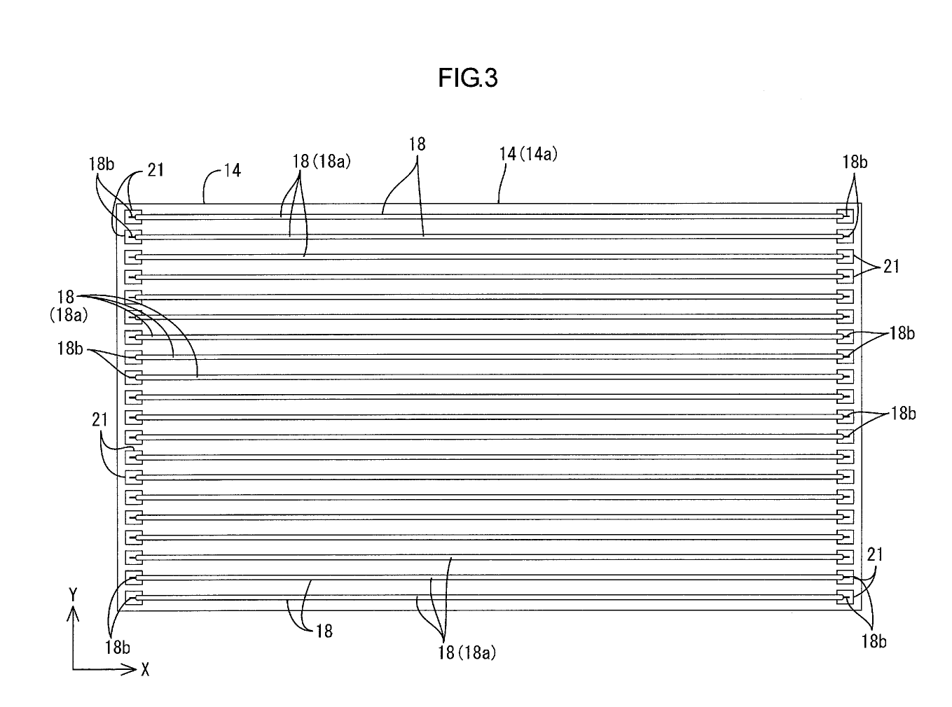

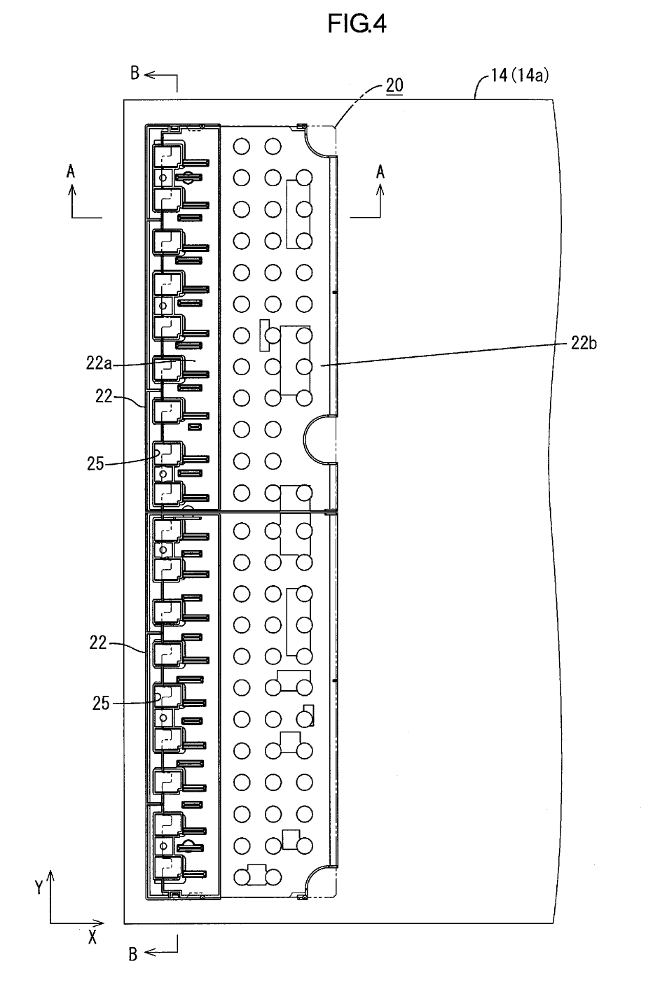

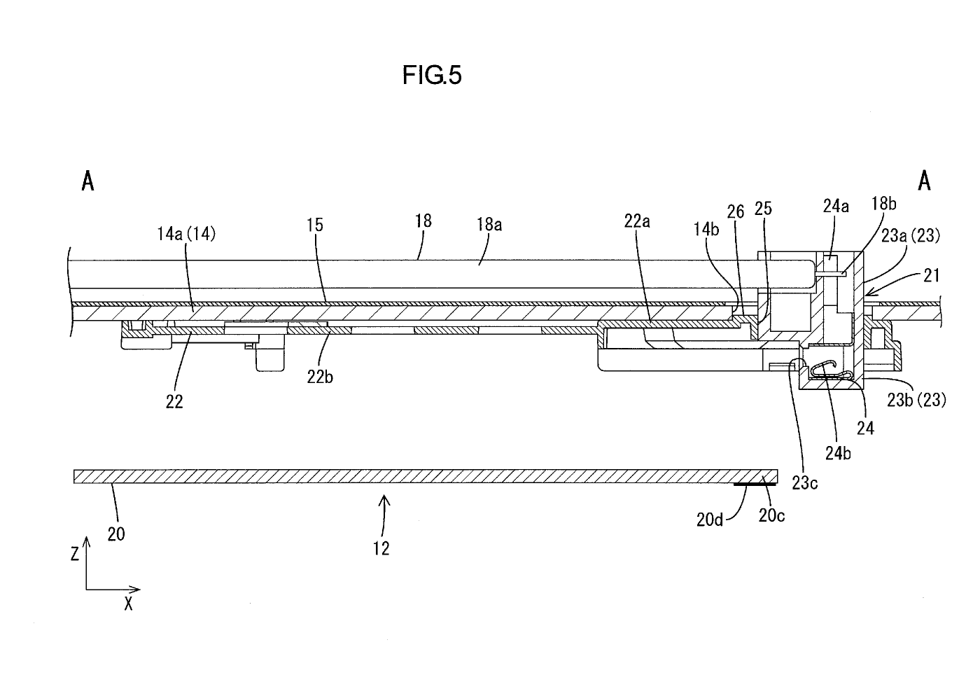

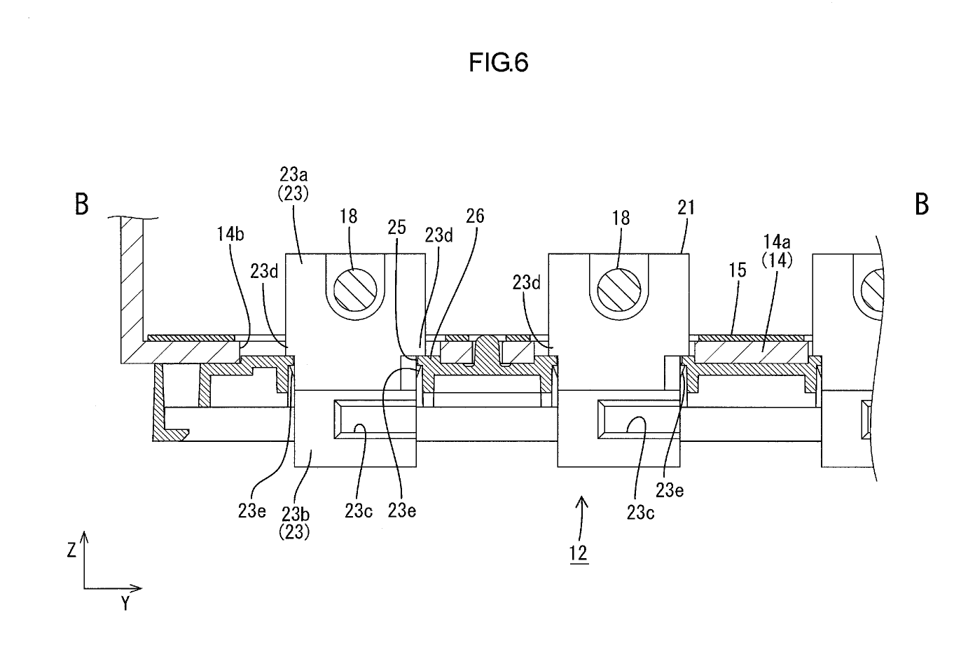

FIG. 1 is an exploded perspective view schematically illustrating a television receiver of the first embodiment according to the present invention. FIG. 2 is a sectional view illustrating a section along a long side of a liquid crystal display device of the television receiver illustrated in FIG. 1. FIG. 3 is a plan view illustrating a chassis with cold cathode tubes housed therein. FIG. 4 is an enlarged bottom view illustrating the chassis with covers thereon. FIG. 5 is a sectional view along line A-A in FIG. 4, with an inverter board in a removed state. FIG. 6 is a sectional view along line B-B in FIG. 4.

X-axes, Y-axes and Z-axes are present in some of the figures to indicate orientations of the liquid crystal display device 10. In FIG. 2, the upper and lower sides correspond to the front side (the front side, the light exit side) and the backside (the rear side, an opposite side from the light exit side), respectively.

As illustrated in FIG. 1, the television receiver TV includes the liquid crystal display device 10 (a display device), a front cabinet Ca, a rear cabinet Cb, a power source P, and a tuner T. The cabinets Ca and Cb sandwich the liquid crystal display device 10 therebetween. The liquid crystal display device 10 is housed in the cabinets Ca and Cb. The liquid crystal display device 10 has a landscape rectangular overall shape. As illustrated in FIG. 2, the liquid crystal display device 10 includes a liquid crystal panel 11, which is a display panel, and a backlight unit 12 (a lighting device), which is an external light source. The liquid crystal panel 11 and the backlight unit 12 are held together by a frame-shaped bezel 13.

Next, the liquid crystal panel 11 and the backlight unit 12 included in the liquid crystal display device 10 will be explained. The liquid crystal display device 10 has a rectangular plan-view shape. As illustrated in FIG. 2, it includes a pair of glass substrates 11a and 11b bonded together with a predetermined gap therebetween and a liquid crystal layer (not shown) sealed between the glass substrates 11a and 11b. On the glass substrate 11a, switching components (e.g., TFTs), pixel electrodes and an alignment film are arranged. The switching components are connected to source lines and gate lines that are perpendicular to each other. The pixel electrodes are connected to the switching components. On the other glass substrate lib, color filter having color sections of three primary colors of red (R), green (G) and blue (B) arranged in a matrix, counter electrodes and an alignment film are arranged. Image data and various kinds of control signals for displaying images are feed from a drive circuit board, which is not shown, to the source lines, the gate lines and the counter electrode. Polarizing plates 11c and 11d are arranged on outer surfaces of the glass substrates 11a and 11b, respectively.

As illustrated in FIG. 2, the backlight unit 12 is a so-called direct backlight including light sources that are arranged directly behind the liquid crystal panel 11. The backlight unit 12 includes a chassis 14, a reflection sheet 15, a plurality of optical members 16, a frame 17, a plurality of cold cathode tubes 18 (light sources), and holders 19. The chassis 14 has a box-like overall shape and an opening on the front side (the light exit side, the liquid crystal panel 11 side). The reflection sheet 15 is placed inside the chassis 14. The optical members 16 are arranged so as to cover the opening. The frame 17 holds the optical members 16. The cold cathode tubes 18 are arranged in a row and housed in the chassis 14. The holders 19 cover the respective ends of the cold cathode tubes 18 so as to block light. Each holder 19 has light reflectivity. The backlight unit 12 further includes inverter boards 20 (power supply boards), relay connectors 21, and covers 22. The inverter boards 20 are arranged on the rear of the chassis 14. The relay connectors 21 are provided for relaying power supply from the inverter boards 20 to the cold cathode tubes 18.

The chassis 14 is made of metal, for instance, aluminum. The chassis 14 includes a bottom plate 14a having a rectangular plan-view shape similar to the liquid crystal panel 11. The long-side direction and the short-side direction of the bottom plate 14a match the X-axis direction and the Y-axis direction indicated in the drawings, respectively. The bottom plate 14a has connector insertion holes 14b in end areas of the long dimension thereof. The connector insertion holes 14b are through holes in which the relay connectors 21 are inserted. A plurality of them (the number required for the cold cathode tubes 18 and the relay connectors 21) are arranged in rows along the Y-axis direction (the short sides of the bottom plate 14a).

The reflection sheet 15 is made of white synthetic resin having high light reflectivity. It is placed over the inner surface of the chassis 14 so as to cover substantially an entire area and configured to reflect rays of light from the cold cathode tubes 18 toward the optical members 16 (the light exit side). The reflection sheet 15 has holes continue into the connector insertion holes 14b.

Each optical member 16 has a rectangular shape similar to the bottom plate 14a of the chassis 14 or the liquid crystal panel 11. The optical members 16 include a diffuser plate, a diffuser sheet, a lens sheet and a brightness enhancement sheet arranged in this order from the rear side. They are configured to convert light emitted from each cold cathode tube, which is a linear light source, into planar light.

The frame 17 is formed in a frame shape along the outer edges of the liquid crystal panel 11 and the optical members 16. The frame 17 is arranged in front of the optical members 16. The outer edges of the optical members 16 are sandwiched between the frame 17 and the holders 19. The frame 17 supports the liquid crystal panel 11 from the rear side. The liquid crystal panel 11 is sandwiched between the frame 17 and the bezel 13 that is arranged in front of the liquid crystal panel 11.

The cold cathode tubes 18 are one kind of linear light sources (tubular light sources). As illustrated in FIG. 3, the cold cathode tubes 18 are mounted inside the chassis 14 with the axial direction thereof (the X-axis direction) aligned with the long-side direction of the chassis 14. They are arranged such that the axes thereof are substantially parallel to each other and a predetermined distance away from each other in the short side direction of the chassis 14 (the Y-axis direction).

The cold cathode tubes 18 are one kind of discharge tubes. As illustrated in FIG. 5, each of them includes an elongated glass tube 18a, a pair of electrodes (not shown) and a pair of outer leads 18b. The glass tube 18a has a circular cross section and closed ends. The electrodes are enclosed in the glass tube 18a and located at the respective ends of the glass tube 18a. The outer leads 18b project from the respective ends of the glass tube 18a to the outside. Mercury that is a luminescent material is sealed in the glass tube 18a and a fluorescent material is applied to the inner walls of the glass tube 18a (neither the luminescent material nor the fluorescent material are shown). Each outer lead 18b is made of metal having electrical conductivity and formed in an elongated round post-like shape. It projects outward (in an opposite direction to the electrode) from the end of the glass tube 18a and extends along the axial direction (the X-axis direction). The internal end of the outer lead 18b is connected to the electrode inside the glass tube 18a and thus the outer lead 18b and the electrode are at the same potential.

Each holder 19 is made of white synthetic resin having high light reflectivity. As illustrated in FIG. 2, it extends along the short side of the chassis 14 and has a box-like shape with an opening on the rear side. The holders 19 are attached to the respective ends of the long side of the chassis 14 so as to collectively cover the respective ends of the cold cathode tubes 18 (non-light-emitting portions) arranged in a row at the ends.

As illustrated in FIG. 5, each relay connector 21 includes a housing 23 and a terminal 24. The housing 23 is made of polybutylene terephthalate resin, nylon, or the like. The relay connector 21 has a substantially block-like overall shape. The terminal 24 is housed in the housing 23. Each relay connector 21 is passed through the bottom plate 14a of the chassis 14 and the cover 22, and is mounted. A part of the housing 23 is disposed inside the chassis 14. That part is a light source holding portion 23a. The light source holding portion 23a holds the corresponding end of the cold cathode tube 18. Another part of the housing 23 is disposed outside the chassis 14. This part is a board holding portion 23b. The board holding portion 23b holds a connecting portion 20c of the inverter board 20, which will be described later. The light source holding portion 23a has an arcuate groove corresponding to a shape of the end of the cold cathode tube 18 (see FIG. 6). The board holding portion 23b has a board holding hole 23c. The board holding hole 23c opens to the rear (toward the inverter board 20) in the X-axis direction. Furthermore, the board holding hole 23c opens to the right in FIG. 6 in the Y-axis direction. As illustrated in FIG. 6, the housing 23 is directly held by the cover 22, not by the chassis 14. Specifically, the light source holding portion 23a includes a wide portion 23d. The light source holding portion 23a with the wide portion 23d has a larger Y-axis dimension than that of the board holding portion 23b. The wide portion 23d is held against a front side of the cover 22. The board holding portion 23b includes stoppers 23e that are connected with a rear side of the cover 22.

As illustrated in FIG. 5, an end of each terminal 24 is disposed in the light source holding portion 23a. That end is a light source contact portion 24a. The light source contact portion 24a contacts the corresponding outer lead 18b of the cold cathode tube 18. Another end of the terminal 24 is disposed in the board holding portion 23b. That end is a board contact portion 24b. The board contact portion 24b contacts the inner connecting portion 20d of the corresponding connecting portion 20c of the inverter board 20, which will be described later. The light source contact portion 24a and the board contact portion 24b have resilience to elastically contact the outer lead 18b and the inner connecting portion 20d, respectively. An output voltage of the inverter board 20 is applied to the outer leads 18b and the electrodes of the cold cathode tubes 18 via the relay connectors 21.

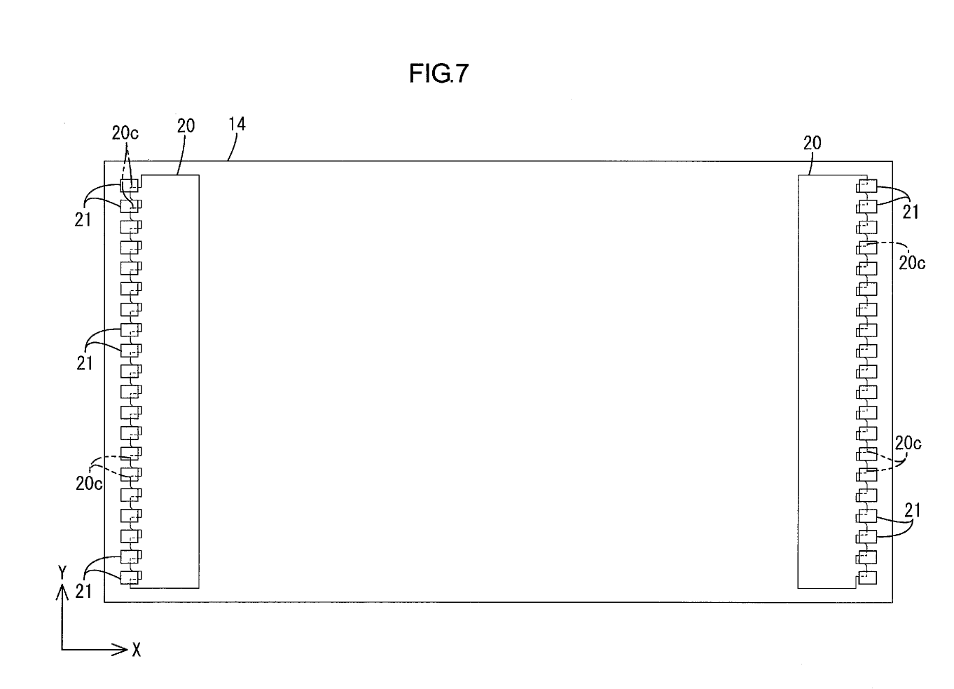

The relay connectors 21 are arranged in pairs. The individual relay connectors 21 in each pair are disposed in positions corresponding to the respective end portions of the corresponding cold cathode tube 18, i.e. are disposed at respective positions located at two ends in the direction along the long sides of the bottom plate 14a of the chassis 14. The relay connectors 21 in pairs are arranged in rows in a direction along the short sides of the bottom plate 14a (or in the Y-axis direction, or in the direction in which the cold cathode tubes 18 are arranged) (see FIG. 7). The number of the relay connectors 21 in each row is equal to the number of the cold cathode tubes 18. The intervals between the relay connectors 21 in each row are substantially equal to the respective intervals between the cold cathode tubes 18. The Y-axis positions of the relay connectors 21 are substantially aligned with those of the cold cathode tubes 18.

Each cover 22 is made of synthetic resin having insulation properties. As illustrated in FIG. 2, the cover 22 is placed between the bottom plate 14a of the chassis 14 and the inverter board 20 (i.e., is held therebetween). It protects the wiring patterns and the chip components 20b on the inverter board 20 from directly touching the bottom plate 14a. The covers 22 are mounted to the rear surface of the bottom plate 14a of the chassis 14 (the surface away from the cold cathode tubes 18) at the ends of the long dimension of the bottom plate 14a in pairs. They cover the areas of the bottom plate 14a in which the relay connectors 21 are arranged.

Specifically, as illustrated in FIG. 4, each cover 22 has a rectangular plan-view shape. The covers 22 are arranged along the Y-axis direction and parallel to each other. The long-side direction thereof is aligned with the short-side direction of the bottom plate 14a. The covers 22 are fixed to the respective ends of the long dimension of the bottom plate 14a with screws. The long dimension of each cover 22 is about a half of the short dimension of the chassis 14 or the long dimension of the inverter board 20. The cover 22 has a plate-like shape and the board surface thereof is parallel to the bottom plate 14a of the chassis 14 and the board surface of the inverter board 20. A part of each cover 22 relatively close to the relay connectors 21 (or the end of the chassis 14) is a front portion 22a, and a part of each cover 22 relatively away from the relay connectors 21 (or close to the middle of the chassis 14) is a rear portion 22b. The rear portion 22b has heat dissipation holes that are through holes for dissipating heat and arranged in a matrix.

The inverter board 20 will be described with reference to FIGS. 2 and 7 to 13.

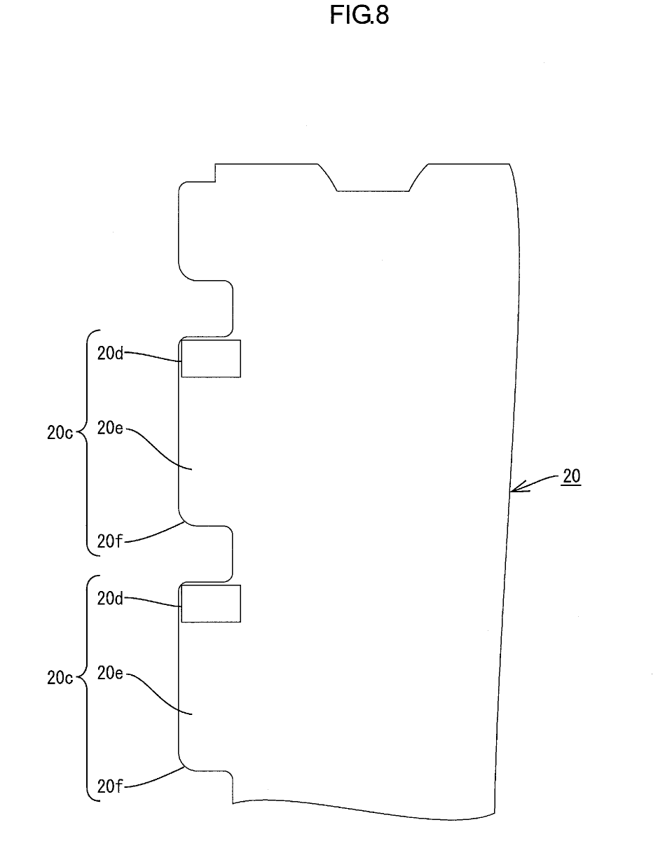

FIG. 7 is a bottom view illustrating the chassis with the inverter board mounted thereto. FIG. 8 is an enlarged plan view illustrating the inverter board.

The inverter board 20 includes a base, a predetermined wiring pattern formed on the base, and electronic components mounted to the base. The base is made of glass fabric base epoxy resin, paper phenol, or the like. Specifically, as illustrated in FIG. 2, lead components 20a including power transformers and capacitors are mounted on the rear surface of the inverter board 20 (the surface away from the chassis 14). On the front surface of the inverter board 20 (the surface close to the chassis 14), wiring patterns (not shown) are formed and chip components 20b including resistors, diodes and capacitors are mounted. Lead of the lead components 20a are passed through the inverter board 20 so as to project from the front surface via the through holes and soldered to the wiring patterns. The chip components 20b are surface-mounted on the wiring patterns on the front surface of the inverter board 20. The inverter board 20 is connected to the power source P of the liquid crystal display device 10. It is configured to step up an input voltage from the power source P and to output a voltage higher than the input voltage. The output voltage is applied to each cold cathode tube 18. The inverter board 20 controls on-and-off of the cold cathode tubes 18. In FIGS. 5 to 13, the lead components 20a and the chip components 20b are not illustrated.

As illustrated in FIG. 7, the inverter boards 20 are mounted on the rear surface of the bottom plate 14a of the chassis 14 (the surface away from the cold cathode tubes 18). The inverter boards 20 are arranged at the respective ends of the long dimension of the bottom plate 14a so as to be symmetric. Each inverter board 20 has a substantially rectangular plan-view shape. The inverter board 20 is placed with the board surface thereof substantially parallel to the board surface of the bottom plate 14a of the chassis 14 (the surface on the X-Y plane and perpendicular to the Z-axis that corresponds to the thickness direction of the liquid crystal display device 10) and with the long-side direction thereof aligned with the short-side direction of the bottom plate 14a (the Y-axis direction, a direction perpendicular to the axial direction of the cold cathode tube 18). The inverter boards 20 are fixed to the bottom plate 14a with screws.

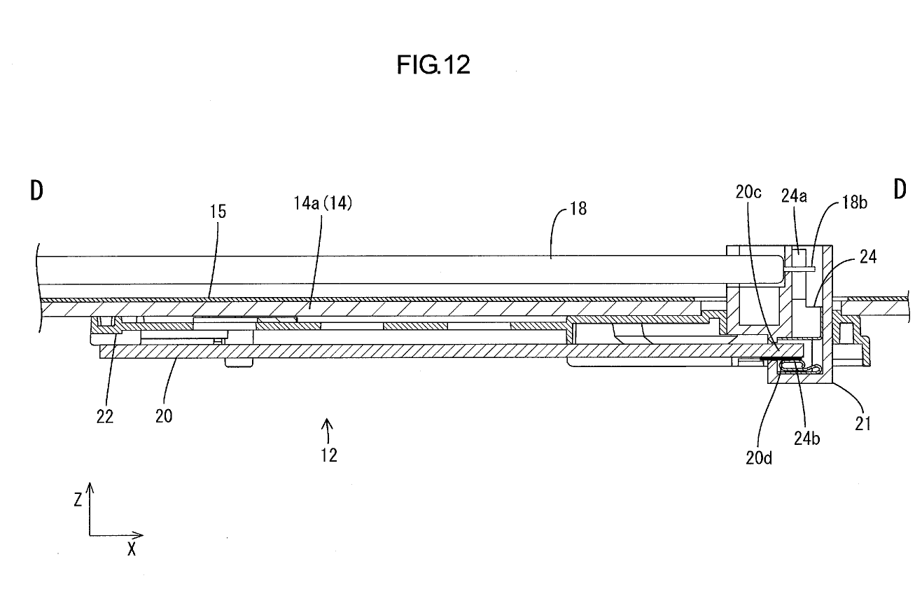

Each inverter board 20 has a front end portion in a direction in which the inverter board 20 is fitted with the relay connector 21. As illustrated in FIG. 8, the front end portion has the connecting portions 20c to be connected with the relay connector 21. A plurality of the connecting portions 20c are provided in a row along the long side of the inverter board 20 (one for each relay connector 21) by cutting out some parts of the front end of the inverter board 20. Namely, the front end of the inverter board 20 is formed in a comb-like shape. As illustrated in FIG. 12, the connecting portions 20c can be individually connected with the respective relay connectors 21. Each connecting portion 20c includes an inner connecting portion 20d and an outer connecting portion 20e. The inner connecting portion 20d is fitted in the relay connector 21. The outer connecting portion 20e is fitted on the relay connector 21 when the inner connecting portion 20d is fitted in the relay connector 21. The inner connecting portion 20d is a terminal that extends from the wiring pattern. The inner connecting portion 20d is electrically connected to the board contact portion 24b of the relay connector 21. The outer connecting portion 20e contacts an outer wall of the housing 23 of the relay connector 21 to hold the inverter board 20 connected to the relay connector 21.

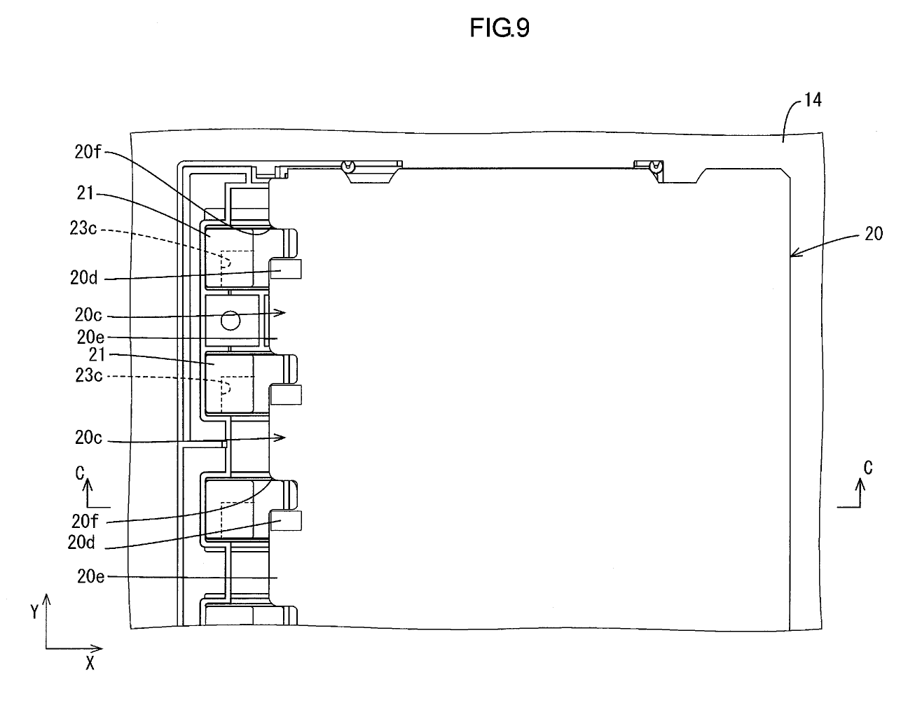

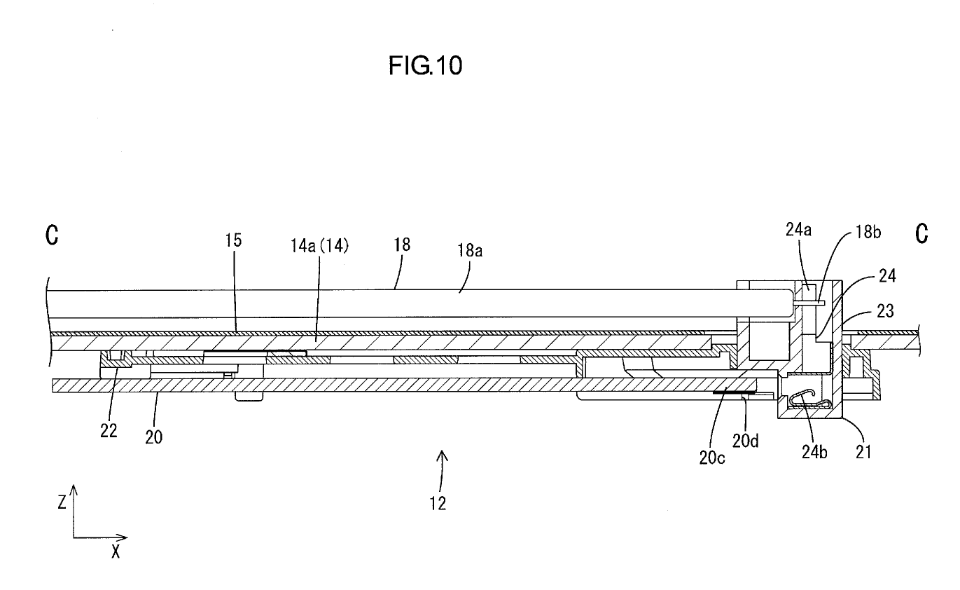

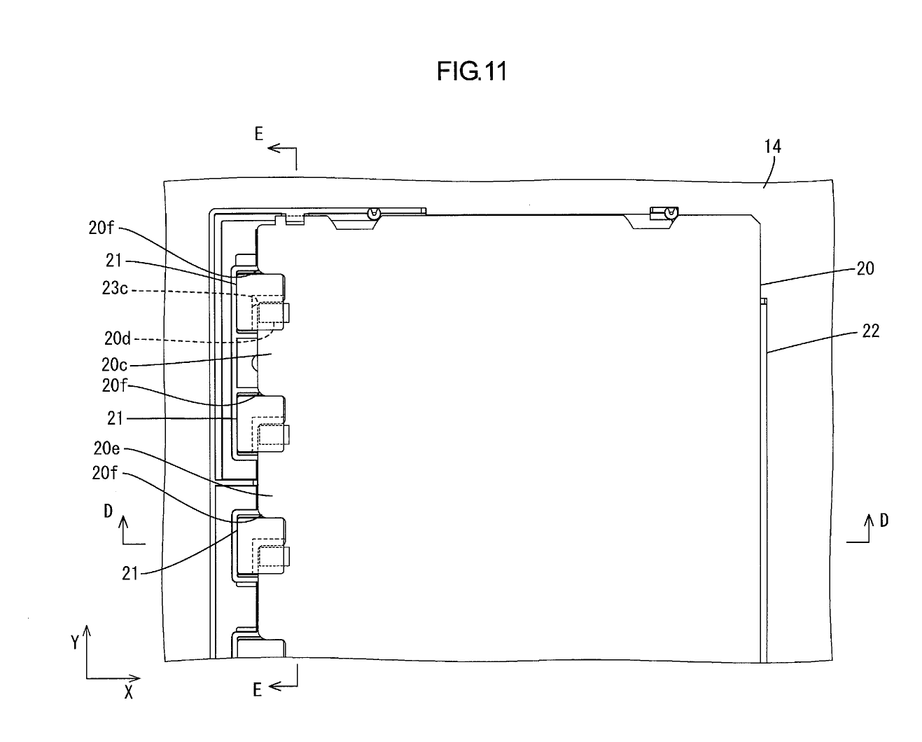

The inverter board 20 can be moved in the X-axis direction (a first direction, a direction along a short side of the inverter board 20) along the board surface of the inverter board 20 between a non-connected position (FIGS. 9 and 10) and a connected position (FIGS. 11 to 13). At the non-connected position, the inverter board 20 is opposed to the bottom plate 14a of the chassis 14 with a predetermined distance therebetween, and the connecting portions 20c are away from the relay connectors 21. At the connected position, the connecting portions 20c are connected with the relay connectors 21 and the inverter board 20 is held with a similar distance from the bottom plate 14a (at a similar Z-axis position) as being at the non-connected position. As illustrated in FIGS. 9 and 10, the connecting portions 20c are located a predetermined distance away in the X-axis direction from the relay connectors 21, and the inner connecting portions 20d are not in contact with the terminals 24 of the relay connectors 21 when the inverter board 20 is at the non-connected position. On the other hand, as illustrated in FIGS. 11 to 13, the connecting portions 20c (the inner connecting portions 20d) are located in the relay connectors 21, and the inner connecting portions 20d are in contact with the terminals 24 when the inverter board 20 is at the connected position. The inverter board 20 can be horizontally moved in the X-axis direction between the non-connected position and the connected position. A direction from the non-connected position toward the connected position is a connecting direction. On the other hand, a direction from the connected position toward the non-connected position is a disconnecting direction. In FIGS. 9 to 12, directions to the right and to the left in the X-axis direction correspond to the connecting direction and the disconnecting direction, respectively. In the following descriptions about the connecting direction and the disconnecting direction of the inverter boards 20 to or from the relay connectors 21, the left inverter board 20 and the left relay connectors 21 in FIG. 7 will be referred to. In descriptions related to backward and frontward directions, directions to the right and left in the X-axis direction in FIGS. 9 to 12 will be referred to as the frontward and backward directions, respectively.

As described above, the inverter board 20 is connected to the relay connectors 21 by being moved from the non-connected position to the connected position while being held the predetermined Z-axis position relative to the chassis 14 and the cover 22. However, during the connection of the inverter board 20 to the relay connectors 21, the connecting portions 20c of the inverter board 20 contact the housings of the relay connectors 21. Therefore, a stress may be applied to the connecting portions 20c.

In particular, the inverter board 20 of this embodiment is made of glass fabric base epoxy resin, while the housings 23 of the relay connectors 21 are made of polybutylene terephthalate. Accordingly, the inverter board 20 has strength smaller than the strength of the relay connector 21. Because of this, the connecting portion 20c is possibly damaged when the connecting portions 20c contact the connecting portions 20c.

As a countermeasure for this, a corner of each connecting portion 20c of the inverter board 20 of this embodiment is rounded as illustrated in FIG. 8. This corner is a rounded corner 20f. More specifically, the outer connecting portion 20e of the connecting portion 20c has a corner to contact the housing 23 of the connector 21. This corner is the rounded corner 20f. The rounded corner 20f is arcuate as viewed perpendicular to the board surface of the inverter board 20. In other words, the rounded corner 20f does not form a right angle.

This embodiment has the above configuration, and its functions of this embodiment will hereinafter be explained. The liquid crystal panel 11 and the backlight unit 12 prepared separately are fixed together by the bezel 13, and the liquid crystal display device 10 having the above configuration is prepared. Assembly of the backlight unit 12 will be explained.

In the assembly of the backlight unit 12, the reflection sheet 15 is placed over the front inner surface of the chassis 14 and the covers 22 are attached to the rear outer surface of the chassis 14. The relay connectors 21 are mounted to the chassis 14 from the inner side of the chassis 14 and fitted in the connector holes of the covers 22. The relay connectors 21 are held by the covers 22. Then, the cold cathode tubes 18 are installed in the chassis 14. The outer leads 18b at the ends thereof are inserted in the light source holding portions 23a of the relay connectors 21 so as to elastically in contact with the light source contact portions 24a of the terminals 24. The holders 19, the optical members 16 and the frame 17 are mounted to the chassis 14 from the front (see FIG. 2).

On the rear side of the chassis 14, the inverter boards 20 are mounted to the chassis 14 and the covers 22. The inverter boards 20 are moved close to the chassis 14 and the covers 22 from the non-connected positions illustrated in FIG. 5 with the surfaces on which the wiring patterns and the chip components 20b are provided on the front side. The inverter boards 20 are moved from the rear side toward the chassis 14 and the covers 22 along the Z-axis direction until they are set at the non-connected positions illustrated in FIGS. 9 and 10. Next, the inverter boards 20 are moved from the non-connected positions to the connected positions. The inverter boards 20 are pushed frontward in the X-axis direction from the non-connected positions. Then, the rounded corner 20f of the connecting portions 20c of the inverter boards 20 contact the corners of the housings 23 of the relay connectors 21. As the inverter board 20 is further pushed frontward, the rounded corners 20f are guided along the housings 23, and the inner connecting portions 20d are fitted into the board holding holes 23c of the respective relay connectors 21. Finally, the inverter boards 20 reach the connected positions. Then, as illustrated in FIGS. 11 to 13, the board contact portions 24b of the terminals 24 of the relay connectors 21 elastically contact the inner connecting portions 20d of the connecting portions 20c. As a result, the inverter boards 20 are electrically relay connected to the cold cathode tubes 18 via the relay connectors 21, so that power supply to the cold cathode tubes 18 becomes available.

As described above, the backlight unit 12 of this embodiment includes the cold cathode tubes 18, the inverter boards 20, and the relay connectors 21. The inverter boards 20 supply drive power to the cold cathode tubes 18. The relay connectors 21 electrically connect the cold cathode tubes 18 to the inverter boards 20. The inverter boards 20 include the connecting portions 20c that are connected with the respective relay connectors 21. By the connection of the connecting portions 20c with the respective relay connectors 21, the inverter boards 20 are electrically connected to the cold cathode tubes 18 via the relay connectors 21. Each connecting portion 20c includes the rounded corner 20f.

The above configuration is advantageous for assembly of the inverter boards 20 and the relay connectors 21. Namely, in the assembly, the connecting portions 20c and the corners of the respective relay connectors 21 can partially contact each other. The rounded corners 20f of the inverter boards 20 are guided along the relay connectors 21. This reduces the stress due to the contact of these members with each other. As a result, the inverter boards 20 are smoothly connected to the relay connectors 21. This prevents damage to the inverter boards 20.

Furthermore, the connecting portions 20c of this embodiment include the respective rounded corners 20f. The rounded corners 20f are provided corresponding to the respective relay connectors 21 arranged in rows.

From a viewpoint of increasing productivity, the connecting portions 20c of the inverter board 20 should be fitted into the respective relay connectors 21 arranged in a row all at once. The inverter board 20, however, probably contacts the relay connectors 21 at slightest misalignment with the relay connectors 21. As the countermeasure for this, each connecting portion 20c has the rounded corner portion 20f, so that the rounded corners 20f are guided along the relay connectors 21. This prevents damage to the inverter board 20.

Furthermore, each relay connector 21 of this embodiment includes the housing 23 made of polybutylene terephthalate, and each inverter board 20 is made of glass fabric base epoxy resin. That is, the inverter board 20 has strength smaller than the strength of the housing 23. Because the connecting portion 20c of the inverter board 20 has the rounded corner 20f, the stress on the connecting portion 20c is reduced. This significantly contributes to preventing the inverter board 20 from damage.

Furthermore, the connecting portion 20c of this embodiment includes the inner connecting portion 20d and the outer connecting portion 20e. The inner connecting portion 20d is fitted in the relay connector 21. The outer connecting portion 20e is fitted on the relay connector 21. The outer connecting portion 20e has the rounded corner 20f.

Because of this configuration, the outside (the housing 23) of the relay connector 21 very probably contacts the outer connecting portion 20e when the inner connecting portion 20d is fitted in the relay connector 21. As a countermeasure for this, the outer connecting portion 20e has the rounded corner portion 20f. Therefore, the rounded corner 20f of the outer connecting portion 20e is guided along the relay connector 21 in fitting operation. This contributes to preventing damage to the outer connecting portion 20e.

### Second Embodiment

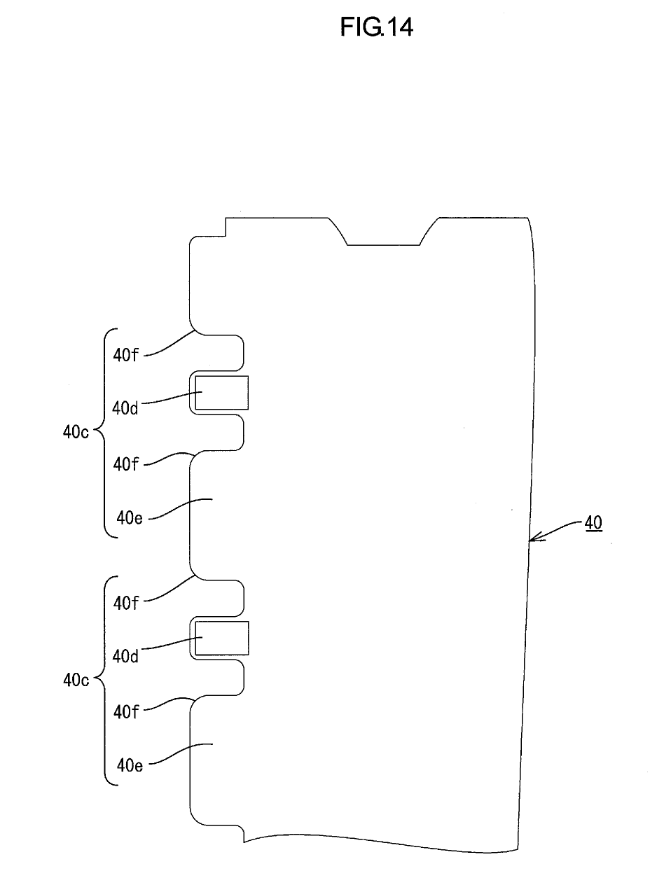

A second embodiment according to the present invention will be described with reference to FIGS. 14 to 17. This embodiment illustrates inverter boards 40 including connecting portions 40c, which are different from those of the first embodiment. The same components as those of the first embodiment will be indicated by the same symbols without repetitive description.

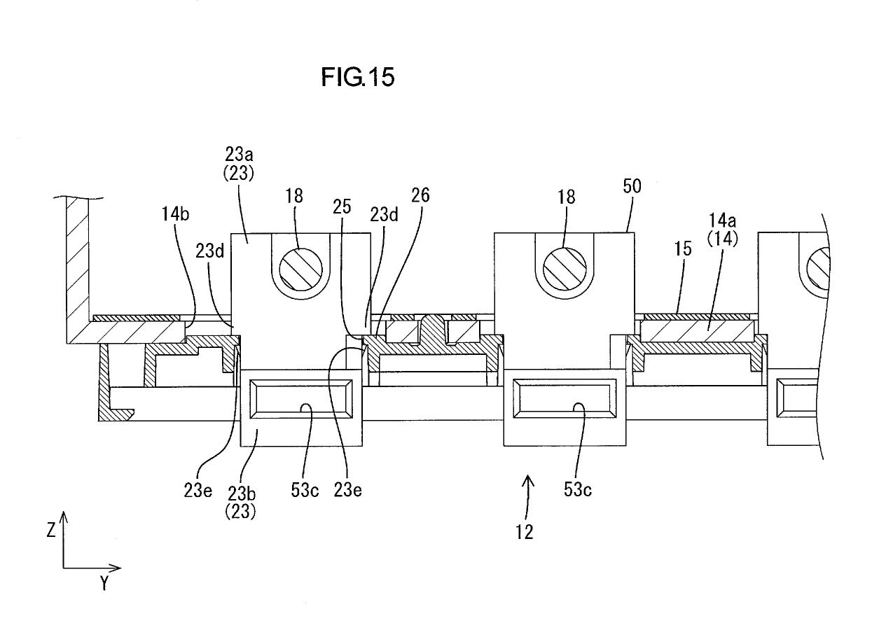

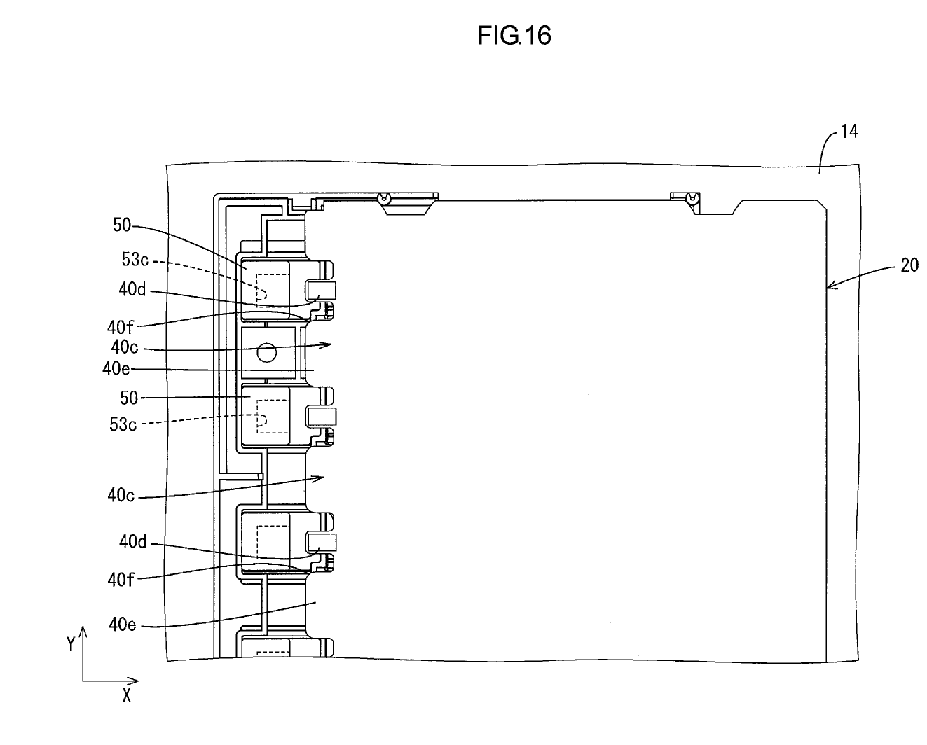

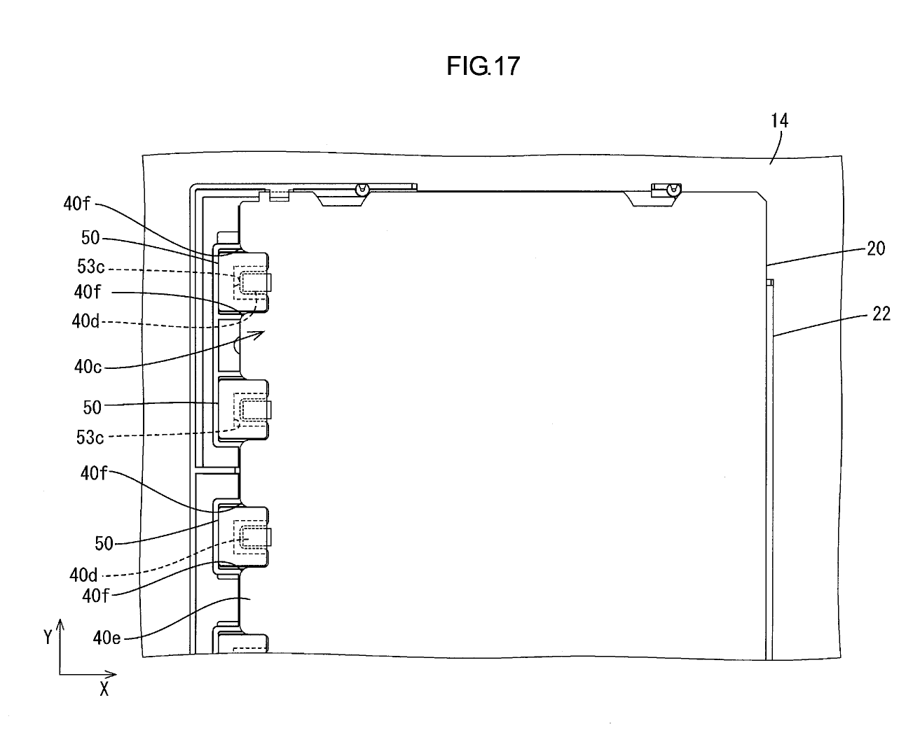

FIG. 14 is an enlarged bottom view illustrating the inverter board of this embodiment. FIG. 15 is a sectional view illustrating the connector. FIG. 16 is an enlarged bottom view illustrating a main part with the inverter board located at the non-connected position. FIG. 17 is an enlarged bottom view illustrating the main part with the inverter board located at the connected position.

As illustrated in FIG. 14, the inverter board 40 includes the connecting portions 40c. Each connecting portion 40c has an inner connecting portion 40d and an outer connecting portion 40e. The inner connecting portion 40d is formed by cutting out some parts of the inverter board 20. The outer connecting portion 40e is adjacent to the connecting portion 40c and is separate from the connecting portion 40c. The connecting portions 40c are arranged in a row in a direction along the long side of the inverter board 40. The number of the connecting portions 40c is same as the number of below-described relay connectors 50. By fitting of the inner connecting portions 40d in the respective relay connectors 50, the inner connecting portions 40d are electrically connected to the board contact portions 24b of the respective relay connectors 50. The outer connecting portions 40e are fitted on the outside of the relay connectors 50 so as to hold the housings 23 of the relay connectors 50 therebetween. Each outer connecting portion 40e has two corners at the end fitted on the relay connectors 50. Each of these corners is a rounded corner 40f.

As illustrated in FIG. 15, a part of the housing 23 of each relay connector 50 is disposed outside the chassis 14. This part is the board holding portion 23b. The board holding portion 23b holds the corresponding connecting portion 40c of the inverter board 40. The board holding portion 23b has a board holding hole 53c. The board holding hole 53c opens toward the inverter board 40. In other words, Y-axis and Z-axis sides of the board holding hole 53c are closed by the housing 23.

The inverter board 40 can be moved in the X-axis direction (the short-side direction of the inverter board 20) along the board surface of the inverter board 20 and between the non-connected position (FIG. 16) and the connected position (FIG. 17). At the non-connected position, the inverter board 20 is opposed to the bottom plate 14a of the chassis 14 with a predetermined distance therebetween, and the connecting portions 20c are away from the relay connectors 50. At the connected position, the connecting portions 20c are connected with the relay connectors 21, and the inverter board 20 is held with a similar distance from the bottom plate 14a (at a similar Z-axis position) as being at the non-connected position.

The inverter board 40 is moved from the non-connected position illustrated in FIG. 16 to the connected position illustrated in FIG. 17 in the following manner. The inverter board 40 is pushed in the X-axis direction toward the relay connector 50. As the inverter board 40 is being pushed, the corners of the connecting portions 40c of the inverter board 40 contact the housings 23 of the respective relay connectors 50. Because the connecting portions 40c (the outer connecting portions 40e) have the rounded corners 40f, the inverter board 40 is pushed while the rounded corners 40 are guided along the housing 23. Finally, the inverter board 40 reaches the connected position. Then, adjacent ones of the outer connecting portions 40e hold the respective relay connectors 50 (the housing 23) therebetween.

As described above, the outer connecting portions 40e of the inverter board 40 of this embodiment hold the relay connectors 50 therebetween. Because of this, the connection between the inverter board 40 and the relay connectors 50 is firmly held. Because the outer connecting portions 40e hold the relay connectors 50 therebetween, the outer connecting portions 40e probably contact the relay connectors 50. As a special countermeasure for this, two corners of each outer connecting portion 40e are rounded. These corners are the rounded corners 40f. Because of this, the rounded corners 40f of the inverter board 40 are guided along the relay connectors 50. This reduces the stress due to the contact between the relay connectors 50 and the inverter board 40.

### Other Embodiment

The present invention is not limited to the above embodiments explained in the above description with reference to the drawings. Following embodiments also are included in the technical scope of the present invention, for example.

(1) In the above-described embodiments, the connecting portion of the inverter board includes the inner connecting portion and the outer connecting portion. The connecting portion may include only the inner connecting portion having a terminal extending from the wiring of the inverter board. The inner connecting portion then has a rounded corner.

(2) Each of the above-described embodiments illustrates the components mounted on the inverter board. The type of components on the inverter board can be modified as properly.

(3) In the above-described embodiments, the covers are provided on the chassis. The covers are not necessarily provided. A positioning structure and the like may be provided directly on the chassis.

(4) In the above-described embodiments, two inverter boards are provided corresponding to the electrodes at the respective ends of the cold cathode tubes. One of the inverter boards is not necessarily provided. That is, the cold cathode tubes may be driven by one-side driving method, with one ends (the lower voltage side) connected to an earth circuit instead of the inverter board.

(5) In the above-described embodiments, the outer leads project from the ends of the glass tubes of the cold cathode tubes. The outer leads are connected to the connectors. The outer leads may be connected to the connectors via ferrules fitted on the ends of the glass tubes.

(6) In the above-described embodiments, the cold cathode tubes are used as the light source. The cold cathode tubes are a type of fluorescent lamps. Another type of fluorescent lamps (such as hot cathode tubes) may be used as the light source. Furthermore, the fluorescent lamps are a kind of discharge tubes. Another kind of discharge tubes (such as mercury lamps) may also be used as the light source.

1. A lighting device comprising:
a light source;
a power supply board configured to supply drive power to the light source; and
a connector that electrically connects the light source to the power supply board, wherein
the power supply board includes a connecting portion connected with the connector so as to be electrically connected to the light source via the connector, and
the connecting portion includes a rounded corner.

2. The lighting device according to claim 1, wherein
the connector includes a plurality of connectors arranged in a row;
the connecting portion of the power supply board includes a plurality of connecting portions arranged in a row so as to be connected with the respective connectors; and
each of the connecting portions has the rounded corner.

3. The lighting device according to claim 1, wherein
the connector further includes a housing made of polybutylene terephthalate;
the connecting portion is connected with the housing; and
the power supply board is made of glass fabric base epoxy resin.

4. The lighting device according to claim 1, wherein:
the connecting portion includes an inner connecting portion and an outer connecting portion;
the inner connecting portion is configured to be fitted in the connector;
the outer connecting portion is configured to be fitted on the connector when the inner connecting portion is fitted in the connector; and
the outer connecting portion includes the rounded corner.

5. A display device comprising:
the lighting device according to claim 1; and
a display panel configured to perform display using light from the lighting device.

6. The display device according to claim 5, wherein
the display panel is a liquid crystal panel including two substrates and liquid crystals sealed therebetween.

7. A television receiver comprising the display device according to claim 5.
